(19) United States
(12) Patent Application Publication
(10) Pub. No.: US 2020/0318343 A1
(43) Pub. Date: Oct. 8, 2020

(54) SCRATCH-PROTECTIVE, AIR-PERMEABLE AND WATERPROOFED PROTECTIVE SHEET

(71) Applicants: Wen-Tung CHANG, New Taipei City (TW); Web-Pro Corporation, Kaohsiung City (TW)

(72) Inventors: Cheng-Chung CHIU, Kaohsiung City (TW); Wen-Tung CHANG, New Taipei City (TW); Ping-Sen LIAO, Kaohsiung City (TW)

(21) Appl. No.: 16/460,890

(22) Filed: Jul. 2, 2019

(30) Foreign Application Priority Data
Apr. 3, 2019 (TW) 108112055

(51) Int. Cl. E04B 1/62; B32B 3/30; B32B 7/12; B32B 5/02; B32B 25/10; E04C 2/24

(52) U.S. Cl. CPC E04B 1/625; B32B 2307/3065; B32B 7/12; B32B 5/022; B32B 25/10; E04C 2/246; B32B 2250/03; B32B 2255/02; B32B 2255/26; B32B 2307/584; B32B 2307/724; B32B 2307/7265; B32B 2607/00; B32B 2471/00; B32B 3/30

(57) ABSTRACT

A scratch-protective, air-permeable and waterproofed protective sheet includes a buffering air-permeable layer, and a first and second scratch-protective combining layer which are laminated respectively on a surface of the buffering air-permeable layer. The buffering air-permeable layer, and the first and second scratch-protective combining layer are air permeable. The buffering air-permeable layer is a non-woven fabric, a fiber material chosen among polyethylene fiber, polyolefin fiber, polyester fiber, cellulose fiber, regenerated cellulose fiber, polyamide fiber, mineral fiber and metallic fiber; whereas, the first and second scratch-protective combining layer are a plastic rubber elastomer chosen from PVC, polyolefin, TPU, TPO, SBS, SEBS, ABS, NBR, CR, Hypalon, natural rubber, IIR, cross-linking elastomer or blend thereof. The first and second scratch-protective combining layer are self-adhesive on both sides, facilitating the leak-proofing from the joining places on overlapped edges of the scratch-protective, air-permeable and waterproofed protective sheet.

### BACKGROUND OF THE INVENTION

### a) Field of the Invention

The present invention relates to a scratch-protective, air-permeable and waterproofed protective sheet used in the furnishing of an indoor building. The sheet is air permeable and soft so that it can be paved flat on a floor or wall easily. In addition, two sides of the scratch-protective, air-permeable and waterproofed protective sheet are provided with a non-skid layer and a self-adhesive layer; therefore, the sheet can facilitate implementation to paste edges and can be covered tightly. Furthermore, as printing or embossing can be performed on a flat surface of the sheet, the requirement for functionality and beauty can be improved.

### b) Description of the Prior Art

In the life of a modern person, he or she will do activities in an indoor building for a long time daily, and the building structure will also need refurbishment and maintenance. In the past, a piece of plywood or hollow plastic board would be used often to cover the floor or wall to prevent from damaging the surface of a floor or wall by the friction or collision due to the moving of a heavy object. On the other hand, one could also use a protective film to cover the floor or wall. However, the protective film is not scratch resistant sufficiently, and the interface area of the protective film is not sealed enough that the working fluid can leak out easily, which may damage the floor or wall permanently by the long-term refurbishment.

A prior art discloses a composite and soft flooding belt and a fabrication method thereof, such as in a Chinese Patent No. CN104647812A. The patent provides a new type of the building waterproofed material which is constituted from bottom to top by a film base, a halogenated-butyl-rubber adhesive layer used for bonding, and a substrate. The said film base is in a folded-shape formed by one-way extrusion into the number of wrinkle strips of no less than 80 strips per 10 cm and the draw rate of no less than 50%; whereas, the thickness of the said halogenated-butyl-rubber adhesive layer is 0.2 mm-3 mm. The patent also introduces the fabrication method of the flooding belt. The flooding belt is provided with the superior anti-aging ability, the persistent adhesiveness and the excellent ductility, which facilitates the implementation and prevents from water leaking effectively.

Another prior art discloses an air-permeable and waterproofed protective device for a floor, such as in a Taiwanese Patent No. M466948. The patent provides an air-permeable and waterproofed protective device which is combined on the surface of a floor, including a protective layer and an air-permeable member. The protective layer is provided with an exterior surface and a combining surface, and the combining surface is combined with the surface of the floor. The air-permeable member is provided with an air duct, and two ends of the air duct are formed respectively with a connecting end and an air-permeable end. The connecting end is disposed on the surface of the floor and the air-permeable end is connected to an outer space. By the abovementioned provision, the capability of waterproofing and air-permeability of the floor can be improved.

Furthermore, a Chinese Patent No. CN1305659C discloses a joining method of fluorine-resin film, a wide fluorine-resin film fabricated by the method and an agricultural covering material made of the film. Two pieces of the film are configured with the end parts being combined together. A center part of the combined area is heated and crimped at a temperature which is larger than 5° C. below the melting point of the fluorine resin and smaller than 20° C. above the melting point of the fluorine resin, and then the entire combined area is heated and crimped at a temperature which is larger than 30° C. below the melting point of the fluorine and smaller than 5° C. below the melting point of the fluorine resin, so that the two pieces of the film can be bonded together by hot melting.

### SUMMARY OF THE INVENTION

The present inventor is fully aware of that the scratch-protective pad or the protective film used in the furbishing work is provided with the issues of fitness, not being implemented easily and needing an extra tape at the overlapped area, as well as that there is still insufficiency to be solved in structures and functions, which results in the development of a scratch-protective, air-permeable and waterproofed protective sheet. The present invention discloses a scratch-protective, air-permeable and waterproofed protective sheet which comprises a buffering air-permeable layer as well as a first scratch-protective combining layer and a second scratch-protective combining layer which are laminated respectively on a surface of the buffering air-permeable layer. The buffering air-permeable layer, the first scratch-protective combining layer and the second scratch-protective combining layer are air permeable. The buffering air-permeable layer is a non-woven fabric which is at least one fiber material among polyethylene fiber, polyolefin fiber, polyester fiber, cellulose fiber, regenerated cellulose fiber, polyamide fiber, mineral fiber and metallic fiber. The first scratch-protective combining layer and the second scratch-protective combining layer are a plastic rubber elastomer, chosen from PVC (Polyvinyl Chloride), polyolefin, TPU (Thermoplastic Polyurethane), TPO (Thermoplastic Olefin), SBS (Styrene-Butadiene-Styrene), SEBS (Styrene Ethyl-Butylene Styrene), ABS (Acrylonitrile-Butadiene-Styrene), NBR (Butadiene-Acrylonitrile Copolymer Rubber), CR (Chloroprene Rubber), Hypalon, natural rubber, IIR (Halogenated Butyl Rubber), cross-linking elastomer or blend thereof. The buffering air-permeable layer is a non-woven fabric which can be a spun-lace fabric, a spun-bond fabric, a needle-punch fabric, a resin-bond fabric, a hot-air fabric, a stitch-bond fabric or a composite fabric thereof. At least a flat surface of the buffering air-permeable layer, the first scratch-protective combining layer or the second scratch-protective combining layer is printed or embossed with at least a pattern to improve the versatility of the product of the scratch-protective, air-permeable and waterproofed protective sheet. The first scratch-protective combining layer and the second scratch-protective combining layer are a fiber adhesive structure, a perforated film structure or a microporous film structure. The surfaces of the first scratch-protective combining layer and the second scratch-protective combining layer are adhesive, with a same or different adhesive force for the two layers. The surfaces of the first scratch-protective combining layer and the second scratch-protective combining layer are smooth. The first scratch-protective combining layer is a plastic-rubber elastomer, into which is added with at least an additive such as a release material, inorganic particles, a flame resisting agent or a viscosity enhancing agent. Similarly, the second scratch-protective combining layer is also a plastic-rubber elastomer, into which is added with at least an additive such as a release material, inorganic particles, a flame resisting agent or a viscosity enhancing agent. The water vapor transmission rate of the scratch-protective, air-permeable and waterproofed protective layer is larger than or equal to 100 g/m²/24 hrs, and is smaller than or equal to 5000 g/m²/24 hrs (M.V.T. [Moisture Vapor Transfer], ASTM [American Society for Testing and Materials] E96-BW); whereas, the hydrostatic pressure of the scratch-protective, air-permeable and waterproofed protective layer is larger than or equal to 10 mmH₂O, and is smaller than or equal to 5000 mmH₂O (W.R.S. [Water Recovery System], AATCC [American Association for Textile Chemists and Colorists] 127). The first scratch-protective combining layer and the second scratch-protective combining layer, being provided with the self-adhesiveness, facilitate the leak-proofed joining at the edges of the scratch-protective, air-permeable and waterproofed protective sheet of the present invention, having a difference in structures than the prior arts as well as an absolute innovation, progressiveness and practicality.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a cutaway view of a scratch-protective, air-permeable and waterproofed protective sheet, according to the present invention.

FIG. 2 shows a cutaway view of the scratch-protective, air-permeable and waterproofed protective sheet s that are overlapped in use, according to the present invention

### DETAILED DESCRIPTION OF THE PREFERRED EMBODIMENTS

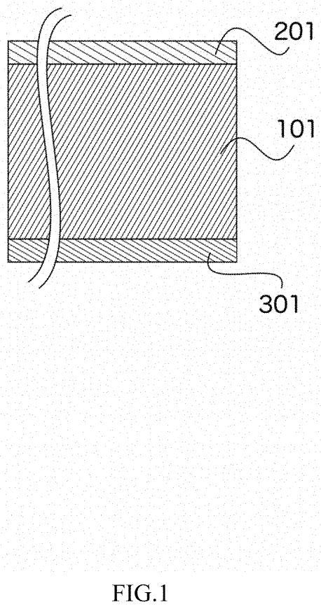

First of all, referring to FIG. 1, it shows a cutaway view of a scratch-protective, air-permeable and waterproofed protective sheet, according to the present invention, comprising a buffering air-permeable layer 101, as well as a first scratch-protective combining layer 201 and a second scratch-protective combining layer 301 which are laminated respectively on a surface of the buffering air-permeably layer 101. The buffering air-permeably layer 101, the first scratch-protective combining layer 201 and the second scratch-protective combining layer 301 are air permeable. The buffering air-permeable layer 101 is a non-woven fabric which is at least one fiber material among polyethylene fiber, polyolefin fiber, polyester fiber, cellulose fiber, regenerated cellulose fiber, polyamide fiber, mineral fiber and metallic fiber. The first scratch-protective combining layer 201 and the second scratch-protective combining layer 301 are a plastic rubber elastomer, chosen from PVC, polyolefin, TPU, TPO, SBS, SEBS, ABS, NBR, CR, Hypalon, natural rubber, IIR, cross-linking elastomer or blend thereof. The buffering air-permeable layer 101 is a non-woven fabric which can be a spun-lace fabric, a spun-bond fabric, a needle-punch fabric, a resin-bond fabric, a hot-air fabric, a stitch-bond fabric or a composite fabric thereof. At least a flat surface of the buffering air-permeable layer 101, the first scratch-protective combining layer 201 or the second scratch-protective combining layer 301 is printed or embossed with at least a pattern to improve the versatility of the product of the scratch-protective, air-permeable and waterproofed protective sheet. The first scratch-protective combining layer 201 and the second scratch-protective combining layer 301 are a fiber adhesive structure, a perforated film structure or a microporous film structure. The surfaces of the first scratch-protective combining layer 201 and the second scratch-protective combining layer 301 are adhesive, with a same or different adhesive force for the two layers. The surfaces of the first scratch-protective combining layer 201 and the second scratch-protective combining layer 301 are smooth. The first scratch-protective combining layer 201 is a plastic-rubber elastomer, into which is added with at least an additive such as a release material, inorganic particles, a flame resisting agent or a viscosity enhancing agent. Similarly, the second scratch-protective combining layer 301 is also a plastic-rubber elastomer, into which is added with at least an additive such as a release material, inorganic particles, a flame resisting agent or a viscosity enhancing agent. The water vapor transmission rate of the scratch-protective, air-permeable and waterproofed protective layer is larger than or equal to 100 g/m²/24 hrs, and is smaller than or equal to 5000 g/m²/24 hrs (M.V.T., ASTM E96-BW); whereas, the hydrostatic pressure of the scratch-protective, air-permeable and waterproofed protective layer is larger than or equal to 10 mmH₂O, and is smaller than or equal to 5000 mmH₂O (W.R.S., AATCC 127).

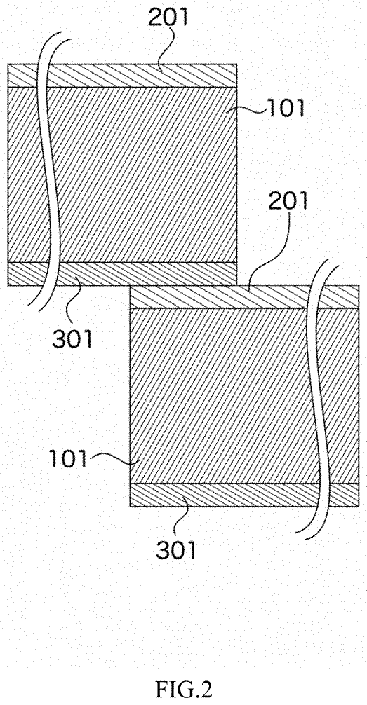

To further understand the practical application of the present invention, an overlapped state on the edges of the scratch-protective, air-permeable and waterproofed protective sheets is taken as an example, as shown in FIG. 2 which is a cutaway view of the scratch-protective, air-permeable and waterproofed protective sheets that are overlapped in use. In the drawing, two scratch-protective, air-permeable and waterproofed protective sheets are all provided with a buffering air-permeable layer 101, as well as a first scratch-protective combining layer 201 and a second scratch-protective combining layer 301 which are laminated respectively on a surface of the buffering air-permeable layer 101. When the edges of the scratch-protective, air-permeable and waterproofed protective sheets are overlapped, the first scratch-protective combining layer 201 on one surface of the sheets is overlapped with the other second scratch-protective combining layer 301. As the surfaces of the first scratch-protective combining layer 201 and the second scratch-protective combining layer 301 are smooth, and the first scratch-protective combining layer 201 and the second scratch-protective combining layer 301 are all self-adhesive that the two overlapped surfaces on the edges can be joined stably and seamlessly, the issue of leaking from the joining places on the edges can be prevented. Furthermore, in comparison to the conventional hollow board or protective film, as the first scratch-protective combining layer 201 is also provided with a non-skid surface, when stepping on the surface of the first scratch-protective combining layer 201 for operation, a builder will not slip easily, which improves the safety in a working place. For other non-overlapped surfaces, as the surface of the second scratch-protective combining layer 301 is also self-adhesive, the scratch-protective, air-permeable and waterproofed protective sheet can be easily adhered on an attached object, without displacing and sliding due to friction caused by an external force. In addition, as the second scratch-protective combining layer 301 is provided with a proper adhesive force, when the scratch-protective, air-permeable and waterproofed protective sheet is removed from the attached object, no residual glue will be available. On the other hand, as the scratch-protective, air-permeable and waterproofed protective sheet is protected by the first scratch-protective combining layer 201 and the second scratch-protective combining layer 301, when the first scratch-protective combining layer 201 is scratched by an external force, there will still be the second scratch-protective combining layer 301 to prevent from leaking, which achieves a dual leak-proofing effect.

The present invention discloses a scratch-protective, air-permeable and waterproofed protective sheet, wherein the buffering air-permeable layer 101 is a non-woven fabric, with air being embedded into the buffering air-permeable layer 101. Therefore, the scratch-protective, air-permeable and waterproofed protective sheet of the present invention can be equipped with a heat insulation effect and a buffering effect against an external force. In addition to being used as a waterproofed sheet, the scratch-protective, air-permeable and waterproofed protective sheet of the present invention can be employed as a heat insulation sheet on a wall or floor inside a building. The buffering air-permeable layer 101 is a non-woven fabric which is chosen from a mineral fiber or a metallic fiber, so that the scratch-protective, air-permeable and waterproofed protective sheet of the present invention can be equipped with a heat-resistant or fire-proofing effect. The characteristics of structures and functions of the present invention are different from that of the prior arts, and the present invention is indeed innovative, progressive and practical. Therefore, the shortcomings in the prior arts can be improved effectively, and the present invention is provided with a significant practicality in use.

Accordingly, the specific structures disclosed by the embodiment of the present invention can actually provide the application of a construction material which is double waterproofing, scratch protective, buffering against an external force, air permeable, heat insulating and fire protective.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A scratch-protective, air-permeable and waterproofed protective sheet, comprising a buffering air-permeable layer as well as a first scratch-protective combining layer and a second scratch-protective combining layer which are laminated respectively on a surface of the buffering air-permeable layer, wherein the buffering air-permeable layer, the first scratch-protective combining layer and the second scratch-protective combining layer are air permeable, with the buffering air-permeable layer being a non-woven fabric which is a fiber material chosen among polyethylene fiber, polyolefin fiber, polyester fiber, cellulose fiber, regenerated cellulose fiber, polyamide fiber, mineral fiber and metallic fiber, whereas the first scratch-protective combining layer and the second scratch-protective combining layer being a plastic rubber elastomer which is chosen from PVC (Polyvinyl Chloride), polyolefin, TPU (Thermoplastic Polyurethane), TPO (Thermoplastic Olefin), SBS (Styrene-Butadiene-Styrene), SEBS (Styrene Ethyl-Butylene Styrene), ABS (Acrylonitrile-Butadiene-Styrene), NBR (Butadiene-Acrylonitrile Copolymer Rubber), CR (Chloroprene Rubber), Hypalon, natural rubber, IIR (Halogenated Butyl Rubber), cross-linking elastomer or blend thereof.

2. The scratch-protective, air-permeable and waterproofed protective sheet according to claim 1, wherein the buffering air-permeable layer is a non-woven fabric which is chosen from a spun-lace fabric, a spun-bond fabric, a needle-punch fabric, a resin-bond fabric, a hot-air fabric, a stitch bonded fabric or a complex-process fabric thereof.

3. The scratch-protective, air-permeable and waterproofed protective sheet according to claim 1, wherein a surface of the buffering air-permeable layer, the first scratch-protective combining layer or the second scratch-protective combining layer is printed or embossed with a pattern to improve the versatility of the product of the scratch-protective, air-permeable and waterproofed protective sheet.

4. The scratch-protective, air-permeable and waterproofed protective sheet according to claim 1, wherein the first scratch-protective combining layer and the second scratch-protective combining layer are a fiber adhesive, a perforated film or a microporous film.

5. The scratch-protective, air-permeable and waterproofed protective sheet according to claim 1, wherein the surfaces of the first scratch-protective combining layer and the second scratch-protective combining layer are adhesive, with a same or different adhesive force for the two layers.

6. The scratch-protective, air-permeable and waterproofed protective sheet according to claim 1, wherein the surfaces of the first scratch-protective combining layer and the second scratch-protective combining layer are smooth.

7. The scratch-protective, air-permeable and waterproofed protective sheet according to claim 1, wherein the first scratch-protective combining layer is a plastic rubber elastomer into which is added with an additive such as a release material, inorganic particles, a flame resisting agent or a viscosity enhancing agent.

8. The scratch-protective, air-permeable and waterproofed protective sheet according to claim 1, wherein the second scratch-protective combining layer is a plastic rubber elastomer into which is added with an additive such as a release material, inorganic particles, a flame resisting agent or a viscosity enhancing agent.

9. The scratch-protective, air-permeable and waterproofed protective sheet according to claim 1, wherein the water vapor transmission rate (M.V.T. [Moisture Vapor Transfer], ASTM [American Society for Testing and Materials] E96-BW) of the scratch-protective, air-permeable and waterproofed protective sheet is larger than or equal to 100 g/m²/24 hrs and smaller than or equal to 5000 g/m²/24 hrs.

10. The scratch-protective, air-permeable and waterproofed protective sheet according to claim 1, wherein the hydrostatic pressure (W.R.S. [Water Recovery System], AATCC [American Association for Textile Chemists and Colorists] 127) of the scratch-protective, air-permeable and waterproofed protective sheet is larger than or equal to 10 mmH₂O and is smaller than or equal to 5000 mmH₂O.
